(19) United States
(12) Patent Application Publication
(10) Pub. No.: US 2006/0267733 A1
(43) Pub. Date: Nov. 30, 2006

(54) Apparatus and methods for saving power in RFID readers

(75) Inventors: Kurt E. Steinke, Ridgefield, WA (US); Patrick S. Watkins, Eugene, OR (US)

Correspondence Address: STOEL RIVES LLP, 900 SW FIFTH AVENUE, SUITE 2600, PORTLAND, OR, 97204-1268, US

(73) Assignee: PSC Scanning, Inc., Eugene, OR (US)

(21) Appl. No.: 11/442,650

(22) Filed: May 26, 2006

Related U.S. Application Data
(63) Continuation-in-part of application No. 11/139,234, filed on May 27, 2005.

(51) Int. Cl. H04Q 5/22

(52) U.S. Cl. 340/10.1; 340/10.3

(57) ABSTRACT

A portable, multi-mode RFID reader is capable of operating in a plurality of interrogation modes. The reader includes a processor configured to select either a subset of the plurality of interrogation modes according to which the RFID reader will operate when interrogating a set of one or more RFID tags, a sequence in which at least some of the plurality of interrogation modes are employed when the RFID reader interrogates the set of RFID tags, or both. Configuration of the processor as described is such that the RFID reader may consume less power, interrogates the set of one or more RFID tags more quickly, or both consume less power and interrogate the set of one or more RFID tags more quickly.

### RELATED APPLICATION DATA

This application is a continuation-in-part of U.S. application Ser. No. 11/139,234, entitled “Apparatus and Method for Saving Power in RFID Readers,” filed May 27, 2005, which is incorporated by reference herein in its entirety.

### TECHNICAL FIELD

The field of the present disclosure relates generally to wireless identification systems and methods, and more specifically, but not exclusively, to an apparatus and methods for saving power in radio frequency identification (RFID) readers.

### BACKGROUND INFORMATION

Electromagnetic tag readers have been developed to electronically sense the identification of an electromagnetically coupled tag over varying distances. RFID transponders are examples of such tags, which are operated in conjunction with RFID readers (or “interrogators”) for a variety of purposes, including inventory control and data collection. An item having a tag associated with it is brought into a read zone established by the RFID reader, or the RFID reader (if portable) is brought near enough to the tag so that the tag is in the RFID reader's read zone.

RFID tags may be either active or passive. Active tags have a self-contained power supply, although the response ability of an active tag may be enhanced with an RFID reader's transmitted RF (radio frequency) power. Passive tags require external excitation when they are to be read within the detection volume of an RFID reader. The RFID reader transmits a continuous-wave interrogating RF signal to the tag (the “downlink”), which is re-modulated by a receiving tag in order to impart information stored within the tag to the signal. The receiving tag then transmits the re-modulated answering RF signal to the reader using modulated backscattering (the “uplink”). The uplink, or return RF signal, is therefore where the tag's antenna is electrically switched, by the modulating signal, from functioning as an absorber of RF radiation to functioning as a generator or reflector of RF radiation. RFID readers are often, but not always, portable to facilitate the mobility of the reader, for instance, in taking inventory in cluttered warehouses.

An antenna connected to a tag's front-end produces an output voltage above some threshold to power the circuit in the tag. This output voltage is obtained within the tag's antenna, together with the tag's front-end circuitry, via electromagnetic induction with the reader's transmitted electromagnetic signal. When sufficient current is induced in the tag, then the output voltage is large enough to operate the RFID circuit, allowing the re-modulation and transmission of the identification signal. In contrast, when the voltage and/or power requirements of the RFID circuit are not fulfilled, the RFID circuit will not resonate. If the received signal strength is not optimal, the distance between the tag reader and the tag must be reduced, or the power of the interrogating signal increased.

In space free of any obstructions or absorption mechanisms, the strength of the electromagnetic field is reduced in inverse proportion to the square of the distance. For a wave propagating through a region in which reflections can arise from the ground and from obstacles or in which materials absorb RF radiation, the reduction in strength can vary quite considerably, in some cases as an inverse fourth power of the distance. Thus, the distance between a tag reader and a tag and the environment in which a tag is interrogated may both have a significant effect on the success of receiving a response from the tag. In some environments, the power of the RFID reader's interrogating signal must be increased and/or the RFID reader's location must be adjusted to successfully read tags present in a geographical area.

Most handheld or portable RFID readers are operated using battery power. As the number of tags to be identified increases, the consumption of power can increase. Continual changing of the battery interrupts workflow, and when the battery is low on power, the reader may provide incorrect reads. Additionally, some RFID readers are multi-technology readers, which include the capability of reading bar codes in addition to other identification codes. As the number of modes of interrogation increase, to include a growing list of RFID protocols, as well as bar code scanning capability, the amount of power drain on an RFID reader continues to increase.

### SUMMARY OF THE DISCLOSURE

Various embodiments are described herein directed to systems and methods for saving power in RFID readers. According to one embodiment, a portable RFID reader is capable of operating in a plurality of interrogation modes. The RFID reader comprises a processor configured to select a subset of one or more of the plurality of interrogation modes according to which the RFID reader will operate when interrogating a set of one or more RFID tags. Alternately, the processor may be configured to select a sequence in which at least some of the plurality of interrogation modes are employed when the RFID reader interrogates a set of one or more RFID tags.

Other embodiment are directed to methods for conserving power in a portable RFID reader capable of operating according to a plurality of interrogation modes during an operation to interrogate a set of one or more RFID tags. One method comprises automatically selecting a subset of the plurality of interrogation modes and operating the RFID reader according to the subset of the plurality of interrogation modes to perform the operation. Another method comprises automatically selecting a sequence of at least some of the plurality of interrogation modes and operating the RFID reader according to the sequence to perform the operation.

According to another embodiment, a portable RFID reader capable of operating in a plurality of interrogation modes comprises memory to store data related to interrogation efficacy of one or more of the interrogation modes and a processor configured to cause the RFID reader to adapt its usage of the interrogation modes so as to conserve power, based on the stored data.

According to yet another embodiment, a method conserves power in an RFID reader capable of operating according to a plurality of interrogation modes when interrogating a set of one or more RFID tags. The method collects data related to interrogation efficacy of one or more of the interrogation modes and adapts usage of the interrogation modes so as to conserve power, based on the stored data.

### BRIEF DESCRIPTION OF THE DRAWINGS

The present embodiments will become more fully apparent from the following description and appended claims, taken in conjunction with the accompanying drawings. Understanding that the accompanying drawings depict only typical embodiments and are therefore not to be considered to limit the scope of the disclosure, the embodiments will be described and explained with specificity and detail in reference to the accompanying drawings, herein described.

FIG. 1 is a diagrammatic view of a multi-mode RFID reader according to one embodiment.

FIG. 2 is a simplified block diagram of the RFID reader of FIG. 1, according to one embodiment.

FIG. 3 is a matrix of employed and excluded interrogation modes utilized by the multi-mode RFID reader of FIG. 1, according to one embodiment.

FIG. 4 is a matrix of a sequence of interrogation modes utilized by the multi-mode RFID reader of FIG. 1, according to one embodiment.

FIG. 5 is a matrix of employed and excluded interrogation modes and the sequence in which employed modes are modes utilized by the multi-mode RFID reader of FIG. 1, according to one embodiment.

FIG. 6 is a flowchart of a method for operating the multi-mode RFID reader of FIG. 1.

FIG. 7 is a flowchart of another method for operating the multi-mode RFID reader of FIG. 1.

FIG. 8 is a flowchart of yet another method for operating the multi-mode RFID reader of FIG. 1.

### DETAILED DESCRIPTION OF EMBODIMENTS

The embodiments described herein will be best understood by reference to the above-listed drawings, wherein like parts are designated by like numerals throughout. It will be readily understood that the components of the embodiments as generally described and illustrated in the figures herein could be arranged and designed in a wide variety of different configurations. Thus, the following more detailed description of various embodiments, as represented in the figures, is not intended to limit the scope of the invention, as claimed, but is merely representative of various embodiments, each of which may differ in a variety of ways. While various aspects of the embodiments are presented in the drawings, the drawings are not necessarily drawn to scale unless specifically indicated. In addition, the steps of a method do not necessarily need to be executed in any specific order, or even sequentially, nor need the steps be executed only once, unless otherwise specified.

The phrases “connected to,” “coupled to,” and “in communication with” refer to any form of interaction directly or indirectly between two or more entities, including mechanical, electrical, magnetic, electromagnetic, fluidic, and thermal interaction. “In electrical communication with” further refers to any form of electrical sending or receiving of any type of electrical signal, for instance, to the extent two structures may communicate electronically. For example, two components may be coupled to each other even though they are not in direct contact with each other.

Certain embodiments may be capable of achieving certain advantages, including some or all of the following: (1) increased efficiency in reading one or more RFID tags; (2) reduced (or conserved) power consumption of a portable RFID reader when interrogating one or more RFID tags; and therefore (3) increased time an RFID reader will operate from a fully charged battery (“charge life”) or reduced battery capacity required to achieve a given charge life, thus reducing weight and cost of the RFID reader. These and other advantages of various embodiments will be apparent upon reading the following.

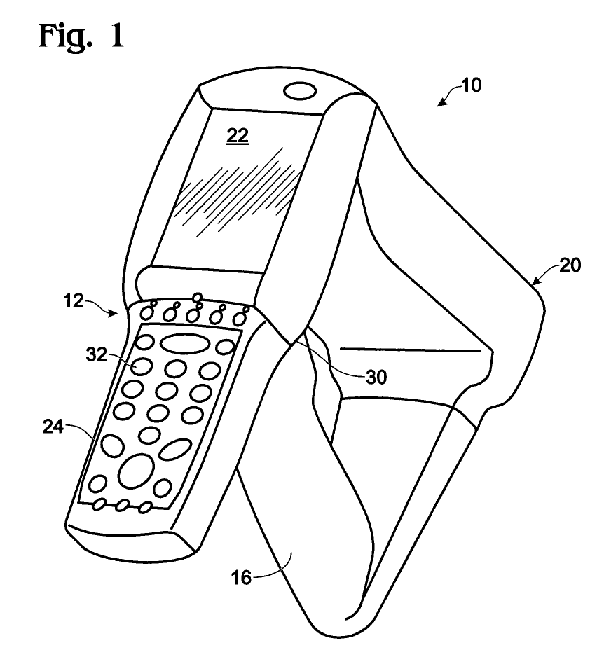

FIG. 1 shows a portable RFID reader 10, which comprises a terminal section 12, a handle 16, and a front section 20. The terminal section 12, which may be based on a portable or handheld computer or the like, includes a display screen 22 and a keypad 24 for providing data input into the reader 10. The display screen 22 may be a touch screen responsive to a finger or stylus (not shown). The front section 20 of the reader 10 includes circuitry for an RFID interrogator to send modulated RF signals to an RFID tag (not shown), and to read RF return or backscatter signals from the RFID tag. The various functions of the reader 10 can be controlled by the terminal section 12. User input can be entered into the reader 10 by using the keypad 24, or the display screen 22 if it is enabled as a touch screen. Within a particular mode of operation, the user may activate a particular read operation by actuating a trigger 30 or a trigger key 32 on the keypad 24. The trigger 30 may be located on the front of the handle 16 for convenient actuation by a user when viewing the display screen 22. In addition, a virtual switch may be used on the touch display screen 22 to activate a read or interrogation operation. In the following, reference will be made to the trigger 30 for simplicity when it is understood that the trigger 30, trigger key 32, or equivalent triggering mechanism is meant.

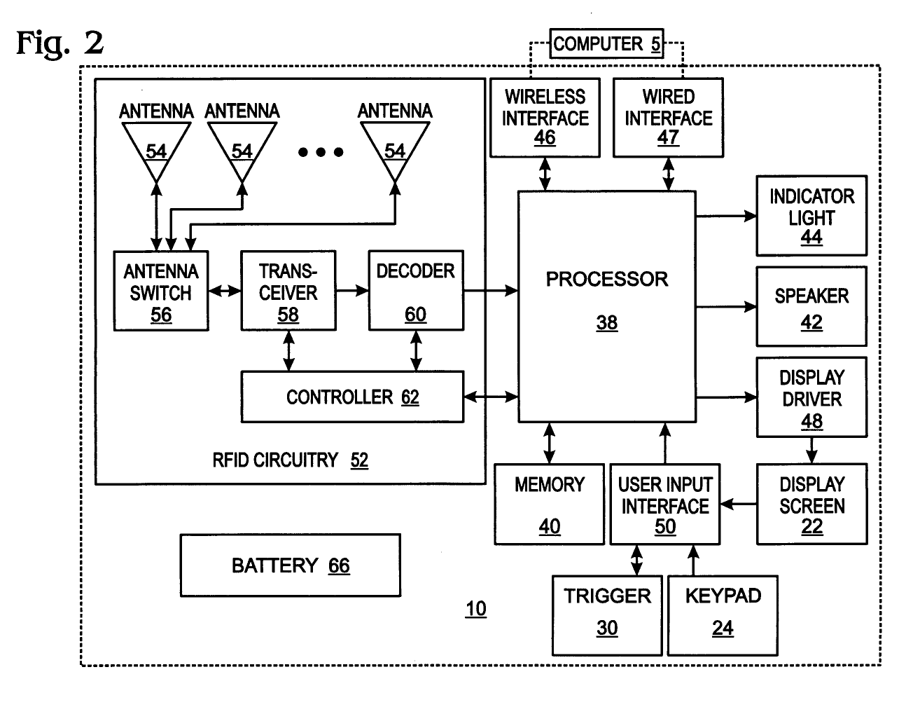

During a read operation, in response to a pull of the trigger 30 or equivalent triggering action, the reader 10 transmits an interrogation signal. Upon receipt of the interrogation signal, an RFID tag may respond by modulating its return or backscatter signal to convey information from the tag. The reader 10 then senses the modulated return signal and processes that signal to obtain the identification data, at which point the reader 10 has successfully “detected” the RFID tag. Although all or part of the processing may occur within the portable terminal 12, which may contain processing functionality (see FIG. 2 below), the reader 10 may transmit the identification data to another computer for processing.

Typically, an RFID interrogation operation in a handheld device, such as the reader 10, is initiated by a trigger pull, which causes a single read command to be sent to read all tags within its RF field. The reader 10 may read multiple tags within a single read operation or tag inventory operation. During an operation known as “painting,” the reader 10 may continuously sweep for RFID tags in its read field while the trigger 30 is held down. While painting, the RFID reader 10 detects and de-conflicts multiple tags, giving some sort of user feedback when each tag is detected and eliminating multiple reads of the same tag. Painting allows the user, during the same trigger pull (or actuation), to move the reader 10 and therefore its read field by moving around, for instance, a pallet, or throughout a room of tags, to detect all tags of interest. Without such movement, there may be certain blind spots out of read range or occluded by interfering objects or electromagnetic fields that prevent reading some tags. Painting is described in the assignee's copending U.S. patent application Ser. No. 11/084,072, entitled “System and Method for RFID Reader Operation”, filed Mar. 16, 2005, which is incorporated herein by reference.

While painting, or otherwise interrogating, one or more RFID tags, the reader 10 may, in general, seek to accomplish one or both of two things: singulate or conduct inventory. A singulation algorithm seeks to detect (or distinguish) a single tag (or specific number of tags) from among many tags. In contrast, an inventory algorithm may be employed to read each tag from among many tags, to thereby record an inventory of items.

The tags detected in a given interrogation operation may be read sequentially according to a suitable protocol such as a query response protocol (QRP) or an air interface protocol (AIP). Such protocols include: (1) Class 0 (zero), which is designed for use with a read-only tag that is programmed at the time the tag is made; and (2) Class 1, which is designed for use with a passive, read-only backscatter tag with a one-time, field-programmable non-volatile memory. Classes 1 and 0 are not interoperable, and are incompatible with ISO (International Organization for Standardization) standards. Additionally, generation 2 (or “Gen 2”) is another protocol that maintains the capabilities of Classes 1 and 0, but attempts to address the deficiencies of those protocols. Finally, the ISO 18000 AIP standards, which cover major frequencies used in RFID systems around the world, are those likely to be used to track goods in a supply chain. At present, different protocols are not designed to operate simultaneously because they would mutually interfere; therefore, in a multi-protocol RFID reader, such as the reader 10, protocols are employed sequentially.

FIG. 2 displays a simplified block diagram of the reader 10. In addition to the components already mentioned, the reader 10 may include a processor 38, a memory 40, a speaker 42, an indicator light 44, a wireless interface 46, a display driver 48, a user input interface 50, and RFID circuitry 52.

The processor 38 may be any form of processor and is preferably a digital processor, such as a general-purpose microprocessor or a digital signal processor (DSP), for example. The processor 38 may be readily programmable by software written in a high-level programming language; hard-wired, such as an application specific integrated circuit (ASIC); or programmable under special circumstances, such as a programmable logic array (PLA) or field programmable gate array (FPGA), for example. Program memory for the processor 38 may be integrated within the processor 38, may be part of a separate memory 40, or may be external to the reader 10.

The processor 38 may execute one or more programs to control the operation of the other components, to transfer data between the other components, to associate data from the various components together (preferably in a suitable data structure), to perform calculations using the data, and to otherwise manipulate the data. For instance, attached to the processor 38 is the user input interface 50, which is an interface to the keypad 24, the trigger 30, and the display 22 if it is a touch screen display. Also attached to the processor 38 is the display driver 48, which is a driver for the display 22. Within the control of the processor 38 may be a number of possible devices, such as a speaker 42 and an indicator light 44, which may be in the form of an LED (light emitting diode) or other suitable visible light device. The speaker 42 and/or the indicator 44 may provide audible and/or visual feedback to a user that an RFID tag or a set of RFID tags has been detected. The keypad 24 or the display 22 provides a versatile and convenient control interface for the reader 10. In one embodiment, a user may select which of the reading mechanisms or interrogation modes to be used, or alternately configure an automatic inventory command for excluding certain interrogation modes.

The memory 40 may store RFID tag data, programs executed on the processor 38, setup or configuration data, data for display, historical performance data, and other data (e.g., protocols, antennas, and orders of search of the protocols and antennas, singulation and inventory algorithms, and adaptation algorithms). The memory 40 may be permanent or removable, and some or all of the memory 40 may be remotely located.

As the reader 10 is portable, it advantageously includes means to communicate remotely with a base (or host) computer 5 or another data reader. A wireless interface 46 is illustrated in FIG. 2 for that purpose, diagrammatically communicating wirelessly with the host computer 5. Through the wireless interface 46, the reader 10 may communicate with the host computer. The host computer may take part in a inventory/tracking process, or may provide external memory for storing data and/or programs used by the multi-mode reader 10, for example. Alternatively, a wired interface 47 may be used in place of or in addition to the wireless interface 46 to interface with a host computer, another data reader, or external peripheral via a cable, wire, tether, bus, land-line or the like. One example of a wired interface is a USB (universal serial bus) interface.

The RFID circuitry 52 of the reader 10 comprises at least one RFID antenna 54 with which the reader 10 communicates with one or more RFID tags. Multiple antennas, as shown, can be connected through an antenna switch 56 to a transceiver 58, which includes both a transmitter and a receiver and may include a modulator, demodulator, frequency synthesizers, amplifiers, filters, and the like. Depending on the frequency bands supported by the reader 10, additional transceivers may be included in the RFID circuitry 52. The RFID circuitry 52 also includes a decoder 60, which decodes the received tag information. A controller 62 controls the operation of the transceiver 58 and the decoder 60 and interfaces with the processor 38. For example, the controller 62 may command the transceiver 58 and/or decoder 60 to operate according to certain interrogation modes, or may relay such commands generated from the processor 38.

Finally, the reader 10 includes a battery 66, which provides power to all of the components of the reader 10 through power connections not shown. The battery 66 is preferably replaceable or rechargeable.

The reader 10 is a multi-mode reader capable of performing interrogation operations according to a plurality of different modes. A mode may be defined in terms of a protocol, antenna, frequency band, frequency hopping pattern or profile, transmission power level, transmission duty cycle during continuous painting operations, etc., or a combination of the foregoing. The reader 10 may be configured to exclude certain interrogation modes. Considerable power can be saved from such exclusions because consumed power is the product of the power per inventory sequence times the number of interrogation modes. Power may also be conserved by intelligently ordering the sequence used by which different modes are employed in attempting interrogation of the tag(s), as will be further discussed below. These power savings may directly influence the charge life of the battery 66 or allow the battery 66 to be smaller while providing similar charge life.

When the RFID reader 10 interrogates a read volume, not all RFID tags in the read volume are always successfully detected. At times, backscattered collisions, power deficiencies, interferences, incompatible RFID protocols, and/or polarization mismatch, etc., may lead to failure to obtain a clear modulated return signal from one or more RFID tags. Therefore, the RFID reader, in one embodiment, may extend a read operation beyond a single read attempt by continuing a sequence of multiple interrogation attempts using a plurality of interrogation modes that are undertaken until meeting a termination criterion. Multiple read attempts may consume significant amounts of power, unless carefully tailored to prevent inefficiently and needlessly continuing interrogation when it would be futile or unlikely to succeed.

The RFID reader 10 may initiate power saving methods via software mechanisms that initiate various algorithms, or manual mechanisms, e.g., manually pulling the trigger 30 on the multi-mode reader 10 with various pulls to initiate the various methods, or using the keypad 24 or the display screen 22 to initiate such methods. These various power saving methods may include, but are not limited to: (1) excluding certain interrogation modes, such as protocols and antennas 54, or combinations thereof, by configuration or adaptation; (2) adjusting a search order of the plurality of interrogation modes, by configuration or adaptation; (3) reducing the reader's transmission duty cycle below 100% when painting; (4) interrogating the RFID tags at a first frequency band, and changing to another frequency band when no RFID tags (or no additional RFID tags) are located; (5) adapting a frequency hopping profile to favor frequencies that yield better read results or to disfavor frequencies that do not work well; (6) terminating frequency hopping and/or painting after an interval when there are no new tags or tag collisions detected, without deactivating the trigger 30; (7) transmitting at successively increasing power levels; and (8) combinations of the above methods.

The inventory command referred to in method (1) above may employ an automated search algorithm, executed by the processor 38, and which may maintain a count of the number of RFID tags found per RFID interrogation at each protocol, antenna, or other interrogation mode of interest. In addition, the automated search algorithm, or another such algorithm, may automatically exclude certain interrogation modes based on historical data gathered from the performance results of such interrogation modes. This historical data may be saved in a data structure, such as a histogram, in the memory 40 to be able to continuously keep the data updated, and thereby keep exclusions or re-sequencing of certain interrogation modes current. Similar types of data may be gathered when executing a “singulation algorithm,” which may have as its focus the period of time that each interrogation mode is unsuccessful. FIGS. 3 through 5 provide examples of possible execution files (or matrices), which may be adapted according to such histograms, as will be discussed with reference thereto, and in the method charts that follow. Note that these matrices may also be recast or implemented by way of lookup tables, databases, or the like.

There are likewise various mechanisms or methods for use at the time of activating the trigger 30, before activating the trigger 30, and/or when terminating a read operation of the RFID reader 10 that help to conserve power. For example, software algorithms may be employed to, in advance, convey to the reader 100 that a user has indicated that a predetermined number of RFID tags are expected in a particular read operation (i.e., that 50 items should be found on a particular pallet or on each of a set of pallets). Once all 50 items are read, the operation is terminated. In addition, the pallet itself may have an RFID tag that contains information as to how many items are on the pallet. Alternately, the information may be stored in a look-up table accessible to the processor 38.

Furthermore, activation criteria may include reducing the transmitter duty cycle below 100% when painting. Reducing the duty cycle can reduce power consumption without reduction in the responsiveness of the RFID reader 10 or in the number of RFID tags found in a sense volume. Responsiveness is not reduced, in part, because the reader 10 may detect tags much quicker than a user may observe the tags being detected; therefore, the tags may be detected in a short period, and then presented to the user on display 22 for perusal. Termination criteria may further include automatically terminating painting after a specific time interval or after a certain number of read attempts (or “polls”) with no new RFID tags detected. This termination scheme reduces power by discontinuing interrogation when a given task is complete, rather than waiting for a user to recognize that the task is complete.

FIG. 3 displays a matrix 300 of employed and excluded interrogation modes utilized by the multi-mode RFID reader 10, according to one embodiment. As displayed, the matrix 300 comprises a plurality of antennas 54 along its columns and a plurality of protocols 74 along its rows. Each X in an individual square represents an excluded interrogation mode. All other (empty) squares represent an employed subset of interrogation modes, usable by the processor 38 to control the RFID circuitry 52 during interrogation when using either a singulation or an inventory algorithm. Although three antennas 54 (A, B, C) are shown, additional or fewer antennas are contemplated and within the scope of this disclosure. The same could be said of the plurality of protocols 74. In addition, each of the columns and/or rows may be replaced with alternate interrogation modes as listed above; such an altered matrix may be sequenced within the order that the processor 38 directs the controller 62 to interrogate the RFID tag(s).

The blocked exclusions X may be pre-programmed subsets of interrogation modes, selected by a user, or adapted by either a user or the RFID reader 10 automatically according to historical performance of certain of the modes. Automatic adaptations within the reader 10 of exclusions in the matrix 300 may occur according to an adaptation algorithm. For instance, such an algorithm may require that if the reader 10 attempts to read a tag with protocol Class 1 using Antenna A, and fails to do so within a certain number of attempts (e.g., 32), then that square of the matrix 300 would be marked with an X as excluded. The counting and tracking of failed attempts may be saved in a histogram file or data structure in the memory 40, and updated as new interrogation results are made available. The matrix 300 may also be saved with its new exclusion(s) in memory 40 for further reference during future RFID interrogation operation. Thus, new results of using a varying number of interrogation modes may be used to decide whether to exclude such interrogation modes from the subset being used by the reader 10 to interrogate one or more RFID tags.

In the matrix 300, using protocols 74 and antennas 54 to define the interrogation modes, is just one example. Other interrogations modes may be substituted for one or both of protocol and antenna selection. Moreover, the possible interrogation modes may differ in only one parameter (e.g., different protocols 74 in a single-antenna RFID reader). In other words, an interrogation mode may be defined in terms of a single interrogation parameter. Conversely, an interrogation mode may be defined by three or more parameters, effectively resulting in a higher dimensional matrix or array of possibilities. The matrix 300 is just one example of a two-parameter universe wherein those two parameters happen to be protocol and antenna.

The above-referenced interrogation modes used for power saving adaptation may be affected by, or include, such factors as the identity of the user, spatial or geographic location, pointing direction of the reader 10, movement, time/day/date, etc. The reader 10 can be equipped with sensors to measure these variables, and the histograms in memory can include fields for these variables. For example, if users undergo a login procedure before using the reader 10, then the identity of the user can be determined and person-specific performance data can be tracked. As another example, the reader 10 can be equipped with a GPS (global positioning system) receiver or other position-determining sensor; angle, tilt or direction sensors; a clock; a calendar; or an inertial sensor, for example.

For instance, multi-mode RFID reader 10 may include adaptation algorithms that are user-specific, tracking the specific user(s) who may use the reader 10. The reader 10 may also use the clock and calendar to track when different individuals are using the reader 10 and what kinds of RFID tags are typically detected when such an individual is working, e.g. during the user's work shift. With an additional matrix configured to track histograms of user-specific data, the RFID reader 10 may adapt itself to use protocols and/or antennas (in addition to other interrogation modes) that most closely match the tags typically detected while a specific user is using the reader 10 and/or during a specific period of time the reader 10 is being used.

As a further example, a user's moving the spatial location or pointing direction of the reader 10 during interrogation, or during painting, may cause new tags to enter the reader's 10 read field and may therefore be a reason to use different interrogation modes (e.g., to change the duty cycle at which a painting signal is transmitted—increased duty cycle when painting a previously unpainted area, or decreased or zero duty cycle when oriented to paint a previously painted area), to alter the order in which interrogation modes are used, or to make other adaptations. When interrogating with certain interrogation modes, spatial location and/or pointing direction may have an effect on an adaptation algorithm employed by processor 38. One example of the latter may include use of different frequency bands that may be more useful in some locations than others because of the environment around and through which an RFID reader 10 is navigated during interrogation. That is, the beam of the RF transmissive power from an antenna 54 will vary as the line of sight of the read field changes to pass through or near various objects, such as metal beams (reflective), electric lines (interfering), or liquid-containing vessels (absorptive).

Therefore, another exclusion matrix may include location along one direction and frequency band along another, which may be adapted for a given period of interrogation, or for interrogation that continues within the same general geographic vicinity. To the extent that frequency bands affect which protocol may be employed (protocols are generally constrained to specific frequency bands), another matrix may be linked to matrix 300, as controlled by the adaptation algorithm. Thus, having various frequency bands triggering exclusionary rules may translate into exclusion of one or more specific protocols.

Another example of adapting the matrix 300 as affected by location or the like includes the transmission power level used in interrogating. For instance, where some locations (despite adapting to a different frequency band) result in large power attenuations, power transmission levels may have to be increased. Otherwise, power can be saved by starting with lower transmission levels first, and increasing them incrementally as required, i.e., through “ramping.” Power ramping is described in the assignee's copending U.S. patent application Ser. No. 11/351,405, entitled “RFID Tag Singulation,” filed Feb. 10, 2006, which is incorporated herein by reference.

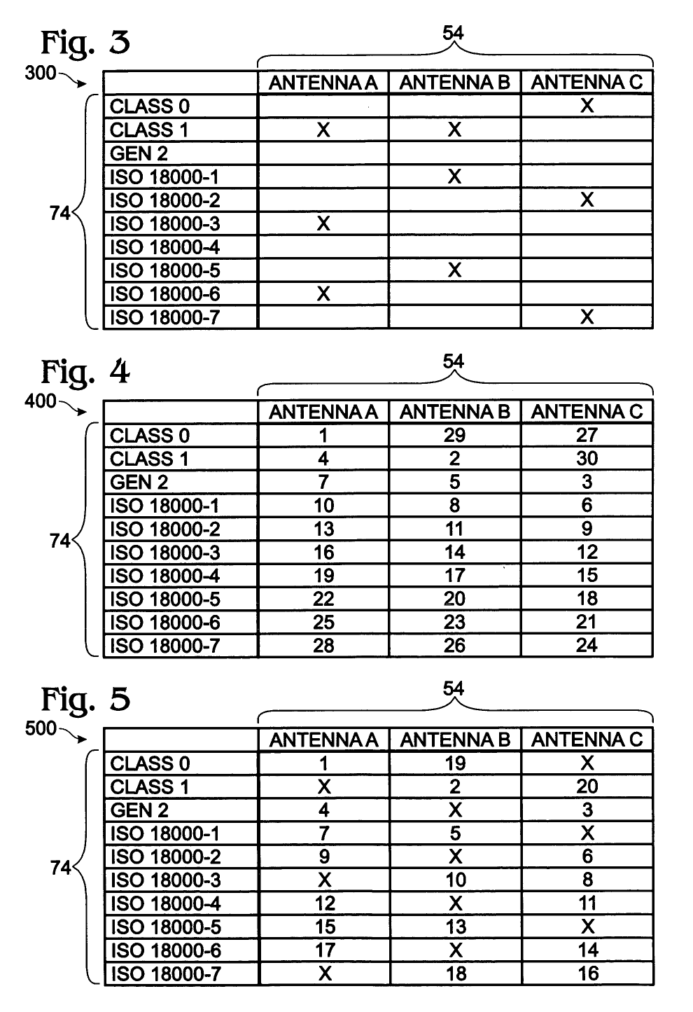

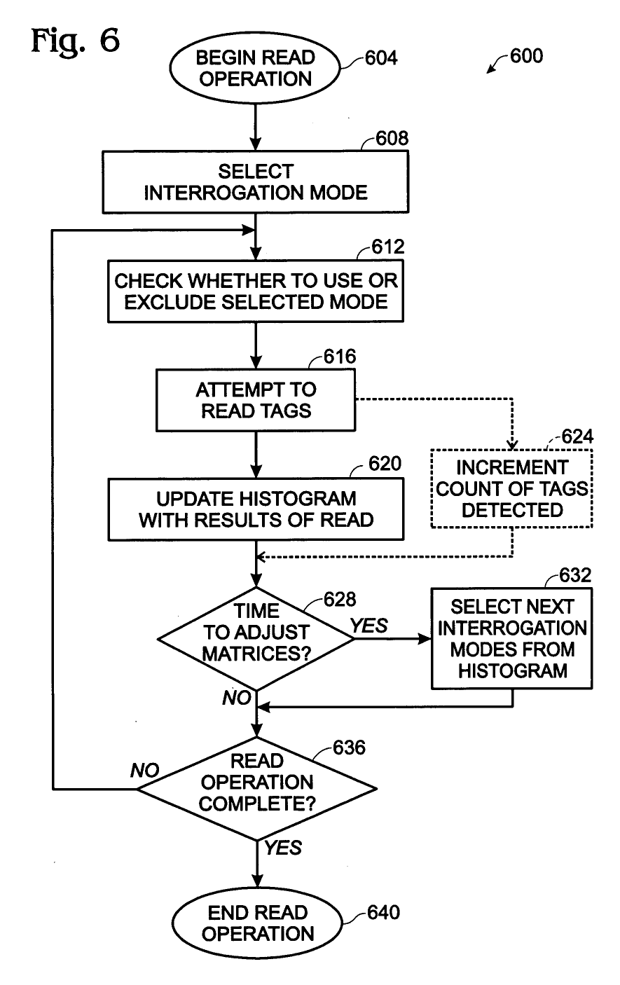

FIG. 4 displays a matrix 400 of a sequence of interrogation modes utilized by the multi-mode RFID reader 10, according to one embodiment. The matrix 400 comprises the same plurality of antennas 54 (A, B, C) and protocols 74 as in the matrix 300, but now each square has a unique number. Each number, from one through thirty, represents one in an order of interrogation as the reader 10 steps through, sequentially, a plurality of unique interrogation modes. The level of uniqueness, of course, also depends on the difference in polarization across the antennas 54. Note that the matrix 400 includes no exclusions of various interrogation modes, but it may include such exclusions as seen in a matrix 500 of FIG. 5. As discussed before, the interrogation modes as combined in the matrix 400 (or 500) may vary, and thus the use of different antennas 54 and protocols 74 is meant to be only exemplary of a particular matrix 400 (or 500).

Like the matrix 300, matrices 400 and 500 may also be adapted by either a user or automatically by the RFID reader 10. Through use of the display 22 or the keypad 24, the user may adjust the search order of the protocols 74, antennas 54, other interrogation parameters, and/or combinations thereof. Alternately, the adjusting of the search order of the antennas 54 and protocols 74 may be performed automatically by the multi-mode reader 10 through employing adaptation algorithms as discussed above. The adaptation algorithm may likewise have the ability to count the number of failed read attempts or otherwise track the tag(s) successfully read, or the period of time that passes without a successful tag read. Here, the adaptation may include cutting short of employing all (thirty) possible interrogation modes where a specific tag or group of tags have been successfully detected, or where no new tag is detected after a period of time or after a certain number of tries. The adaptation may also include re-ordering the sequence of the interrogation modes as depicted in each square, or by deciding to exclude a square for similar reasons as discussed with reference to FIG. 3.

The matrix 500 in FIG. 5 shows employed and excluded interrogation modes and the sequence in which employed modes are modes utilized by the multi-mode RFID reader of FIG. 1, according to one embodiment. The matrix 500 comprises the same plurality of antennas 54 (A, B, C) and protocols 74 as in the matrix 400, but now the sequence is the order of performing the non-excluded subset of interrogation modes. The excluded interrogation modes, again indicated by an X, may be excluded prior to the beginning of interrogation, be excluded by a user via the display screen 22 or the keypad 24, or may be dynamically excluded as adapted to by reader 10, as discussed previously. In addition, as certain interrogation modes are excluded (whether a priori or a posteriori in time) the remaining interrogation modes available to the reader 10 may be dynamically renumbered and/or adapted in sequence as discussed previously. For example, depending on a particular adaptation algorithm, an interrogation mode that is increasingly failing to successfully interrogate any RFID tag, may find itself at the bottom of an interrogation sequence, and eventually, as an excluded interrogation mode.

Matrices such as 300, 400, 500, and variations thereto, may continually be updated according to adaptation algorithms, which access histograms stored in memory. Histograms may be updated by the same (or different) adaptation algorithms to continue to provide the algorithms the “intelligence” with which to make decisions to exclude and/or re-sequence available interrogation modes. Because such adaptations are sometimes tied to a particular user's business or typical inventory, as well as to a typical geographic area in which inventory or singulation takes place, these matrices and histograms may often continue to be relevant and useful over long periods of time. However, if a user changes drastically its business in geography or types of RFID tags being read, it may be useful to reset the RFID reader 10 so that the adaptation process begins from scratch. A user may also be able to provide a “jump start” to the adaptation process by excluding certain protocols, frequencies, antennas, etc., that the user knows will not yield successful tag detections. This user-inputted data may be treated equivalently (or unequally) to adaptation data gathered as part of the continual operation of the RFID reader 10 thereafter, according to user preference.

Finally, the multi-mode RFID reader 10 may be integrated into a multiple technology reader, for instance, in which a bar code scanner or other electronic identification system is also employed. Such a multiple-technology reader may have additional interrogation modes due to the nature of having additional identification means integrated with reader 10; therefore, such a multiple-technology reader falls within the scope and spirit of this disclosure. One example of a multiple-technology data reader is disclosed in U.S. Pat. No. 6,415,978, issued to McAllister, entitled “Multiple Technology Data Reader For Bar Code Labels And RFID Tags.”

FIG. 6 is a flowchart of a method 600 for operating the multi-mode RFID reader 10. In this embodiment, the read operation begins at step 604 by selecting at step 608 from a plurality (or subset) of interrogation modes available to the multi-mode reader 10. As an additional step, the reader 10, through an adaptation algorithm, may further decide at step 612 whether to use or to exclude the selected modes. As discussed previously, this step may initially be taken through direct user decision, or through the reader 10 making a default decision. The reader 10 then attempts at step 616 to read the tags. Whatever the result of this read attempt (successful or not), the reader 10 updates at step 620 a related histogram in the memory 40 with the results of the read. When using an inventory algorithm, for instance, the reader 10 may also increment at step 624 a count of the number of tags detected using a particular interrogation mode, such as a specific protocol. Such a count may eventually be used to exclude or re-sequence certain interrogation modes.

Before taking further adaptation action, however, the reader 10 will determine at step 628 if there is enough time before the next read attempt to adjust one or more matrices (or tables, or databases, or the like) affected by the updated histogram. If the answer is yes, then the reader 10 selects at step 632 the next interrogation modes from the histogram with which to update the matrices, which in turn dictate the subset and/or sequence of the interrogation modes employed. If the answer is no, then the reader 10 determines at step 636 if the read operation is complete, and ends at step 640 the read operation if it is. If it is not complete, for instance while painting where read attempts are consecutive, the reader 10 goes directly back to step 612, in which the reader 10 decides whether to use or exclude selected modes available for employment in interrogation.

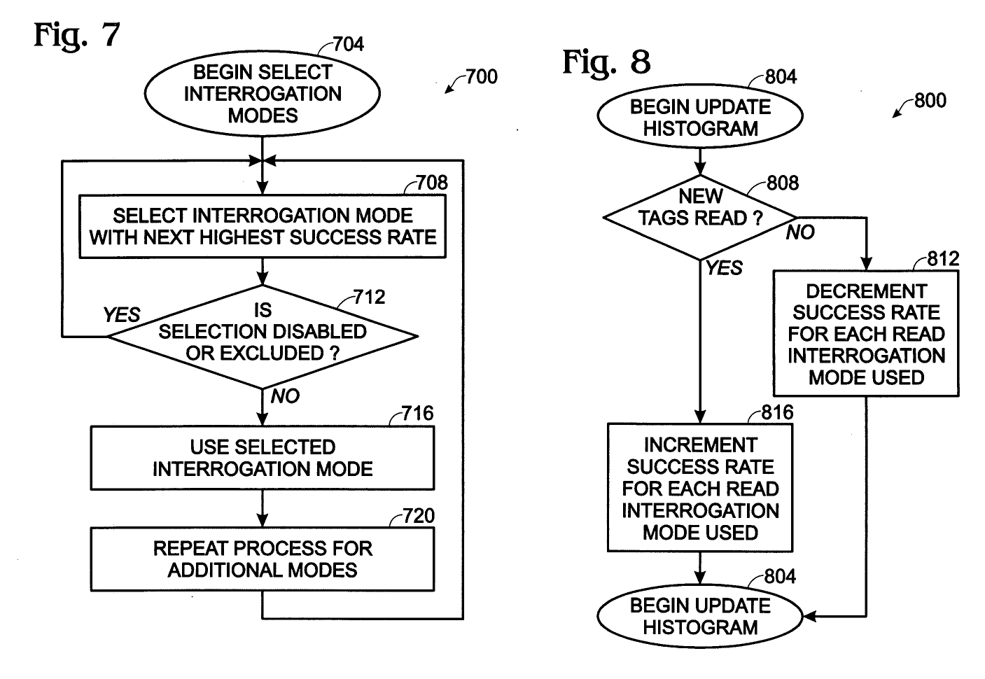

FIG. 7 is a flowchart of another method 700 for operating the multi-mode RFID reader 10. The reader 10 in this embodiment may begin at step 704 by selection of an interrogation mode. After each read attempt, the method may select at step 708 the interrogation mode with the next highest success rate, and sequentially work through a matrix such as the matrix 400. This method 700 may also allow for adaptation as the sequence changes according to the level of success of each interrogation mode over time. The reader may further determine at step 712 if the selected interrogation mode is disabled (e.g., by a user) or excluded (e.g., by a user or by adaptation). If the interrogation mode is either disabled or excluded, it is unavailable so the reader 10 repeats at step 716 the method 700 by selecting at step 708 the interrogation mode with the next highest success rate. This step 716 further implements a matrix such as the matrix 500 in which a subset of the interrogation modes are excluded, as indicated with an X. All the remaining interrogation modes in the matrix 500 may then be sequenced, according to ranking, by tag detection success rates.

Finally, if the interrogation mode is not disabled or excluded, it is available, and method 700 continues by using at step 716 the selected interrogation mode during interrogation. The reader 10 may then, at step 720, repeat the method 700 by selecting at step 708 the interrogation mode with the next highest success rate, thereby allowing the adaptation process to continue throughout interrogation. The success rate may be tracked in parallel with method 700, as is described in FIG. 8 below.

FIG. 8 is a flowchart of yet another method 800 for operating the multi-mode RFID reader 10. In the method 800, the multi-mode reader 10 may begin at step 804 update of a histogram by determining at step 808 if a new tag has been read. If the answer is no, the method 800 decrements at step 812 a success rate count for each interrogation mode being utilized at the time of the attempt. If the answer is yes, then the method 800 increments at step 816 the success rate count for each interrogation mode being utilized. This process then repeats itself in order to keep each histogram updated during interrogation, for purposes of timely adaptation by the reader 10 as depicted in FIGS. 3-5 and FIG. 7.

The methods 600, 700, 800, and other methods for interrogating a tag illustrated and described herein may exist in a variety of forms, both active and inactive. For example, they may exist as one or more software or firmware programs comprised of program instructions in source code, object code, executable code or other formats. Any of the above may be embodied on a computer-readable medium, which include storage devices and signals, in compressed or uncompressed form. Exemplary computer-readable storage devices include conventional computer system RAM (random access memory), ROM (read only memory), EPROM (erasable, programmable ROM), EEPROM (electrically erasable, programmable ROM), flash memory and magnetic or optical disks or tapes. Exemplary computer-readable signals, whether modulated using a carrier or not, are signals that a computer system hosting or running a computer program may be configured to access, including signals downloaded through the Internet or other networks. Concrete examples of the foregoing include distribution of software on a CD ROM or via Internet download. In a sense, the Internet itself, as an abstract entity, is a computer-readable medium. The same is true of computer networks in general.

The terms and descriptions used herein are set forth by way of illustration only and are not meant as limitations. Those skilled in the art will recognize that many variations can be made to the details of the above-described embodiments without departing from the underlying principles of the invention. The scope of the invention should therefore be determined only by the following claims (and their equivalents) in which all terms are to be understood in their broadest reasonable sense.

1. A portable RFID reader capable of operating in a plurality of interrogation modes, the RFID reader comprising a processor configured to select a subset of the plurality of interrogation modes according to which the RFID reader operates when interrogating a set of one or more RFID tags.

2. An RFID reader according to claim 1, wherein the plurality of interrogation modes comprises a plurality of interrogation protocols.

3. An RFID reader according to claim 2, wherein the plurality of interrogation protocols includes an RFID protocol selected from the group consisting of: class 0, class 1, and generation 2.

4. An RFID reader according to claim 1, wherein the plurality of interrogation modes comprises interrogation by a plurality of antennas.

5. An RFID reader according to claim 4, wherein the plurality of antennas comprises two or more antennas differing from one another in polarization.

6. An RFID reader according to claim 1, wherein the plurality of interrogation modes comprises a plurality of transmission power levels.

7. An RFID reader according to claim 1, wherein the plurality of interrogation modes comprises a plurality of transmission duty cycles.

8. An RFID reader according to claim 1, wherein the plurality of interrogation modes comprises a plurality of transmission frequency hopping profiles.

9. An RFID reader according to claim 1, wherein the plurality of interrogation modes comprises a plurality of transmission frequency bands.

10. An RFID reader according to claim 1, wherein the processor is further configured to select an order in which the subset of the plurality of interrogation modes is employed.

11. An RFID reader according to claim 1, further comprising:
memory to store data concerning the performance of the RFID reader in at least one of the plurality of interrogation modes; and
wherein the processor selects the subset of the plurality of interrogation modes based on the data.

12. An RFID reader according to claim 11, wherein the data comprises historical data from past operation of the RFID reader.

13. An RFID reader according to claim 11, wherein the processor is further configured to update the data concerning the performance of the RFID reader as the RFID reader operates.

14. An RFID reader according to claim 13, wherein the processor is further configured to adapt the subset of the plurality of interrogation modes according to which the RFID reader operates based on the data.

15. An RFID reader according to claim 1, wherein the processor is further configured to accept input from a user of the RFID reader, and wherein the processor selects the subset of the plurality of interrogation modes based on the input.

16. An RFID reader according to claim 1, wherein the processor is further configured to cause the RFID reader to perform a painting operation using the selected subset of the plurality of interrogation modes.

17. An RFID reader according to claim 1, wherein the processor is further configured to cause the RFID reader to perform a singulation operation using the selected subset of the plurality of interrogation modes.

18. A portable RFID reader capable of operating in a plurality of interrogation modes, the RFID reader comprising a processor configured to select a sequence in which at least some of the plurality of interrogation modes are employed when the RFID reader interrogates a set of one or more RFID tags.

19. An RFID reader according to claim 18, wherein the sequence is a based on input from a user of the RFID reader.

20. An RFID reader according to claim 18, further comprising:
memory to store data concerning performance of the RFID reader in at least one of the plurality of interrogation modes; and
wherein the processor selects the sequence based on the data.

21. An RFID reader according to claim 18, further comprising:
wherein the processor is further configured to select a subset of the plurality of interrogation modes, and the sequence consists of the subset.

22. A method for conserving power in a portable RFID reader capable of operating according to a plurality of interrogation modes during an operation to interrogate a set of one or more RFID tags, the method comprising:
automatically selecting a subset of the plurality of interrogation modes; and
operating the RFID reader according to the subset of the plurality of interrogation modes to perform the operation.

23. A method according to claim 22, further comprising:
accepting input from a user of the RFID reader; and
wherein the step of automatically selecting a subset of the plurality of interrogation modes is based on the input.

24. A method according to claim 22, further comprising:
collecting data concerning the performance of the RFID reader in at least one of the plurality of interrogation modes; and
wherein the step of automatically selecting a subset of the plurality of interrogation modes is based on the data.

25. A method according to claim 22, further comprising:
selecting a sequence in which the subset of the plurality of interrogation modes are employed.

26. A method according to claim 22, wherein the operation is selected from the group consisting of: a painting operation and a singulation operation.

27. A method for conserving power in a portable RFID reader capable of operating according to a plurality of interrogation modes during an operation to interrogate a set of one or more RFID tags, the method comprising:
automatically selecting a sequence of at least some of the plurality of interrogation modes; and
operating the RFID reader according to the sequence to perform the operation.

28. A method according to claim 27, further comprising:
accepting input from a user of the RFID reader; and
wherein the step of automatically selecting a sequence is based on the input.

29. A method according to claim 27, further comprising:
collecting data concerning the performance of the RFID reader in at least one of the plurality of interrogation modes; and
wherein the step of automatically selecting a sequence is based on the data.

30. A method according to claim 27, further comprising:
selecting a subset of the plurality of interrogation modes, wherein the sequence consists of the subset.

31. A portable RFID reader capable of operating according to a plurality of interrogation modes during an operation to interrogate a set of one or more RFID tags, the RFID reader comprising:
means for automatically selecting at least one of a subset of the plurality of interrogation modes and a sequence of at least some of the plurality of interrogation modes; and
means for operating the RFID reader according to the subset of the plurality of interrogation modes to perform the operation.

32. A portable RFID reader capable of operating in a plurality of interrogation modes, the RFID reader comprising:
memory to store data related to interrogation efficacy of one or more of the interrogation modes; and
a processor configured to cause the RFID reader to adapt its usage of the interrogation modes so as to conserve power, based on the stored data.

33. An RFID reader according to claim 32, wherein the processor updates the stored data based on new results from continued operation of the RFID reader.

34. An RFID reader according to claim 32, wherein the processor adapts at least one of a duty cycle at which the RFID reader transmits an interrogation signal, a frequency band at which the RFID reader transmits an interrogation signal, and a frequency hopping profile according to which the RFID reader transmits an interrogation signal.

35. An RFID reader according to claim 32, wherein the processor adapts its usage of the interrogation modes by excluding at least one interrogation protocol from use.

36. An RFID reader according to claim 32, further comprising:
a plurality of antennas; and
wherein the processor adapts its usage of the interrogation modes by excluding at least one of said plurality of antennas from use.

37. An RFID reader according to claim 32, further comprising:
a plurality of antennas; and
wherein the processor adapts its usage of the interrogation modes by excluding at least one combination of one of said plurality of antennas and an interrogation protocol from use.

38. An RFID reader according to claim 32, wherein the processor adapts its usage of the interrogation modes by varying an order in which a plurality of interrogation protocols are used.

39. An RFID reader according to claim 32, further comprising:
a plurality of antennas; and
wherein the processor adapts its usage of the interrogation modes by varying an order in which at least some of said plurality of antennas are used.

40. An RFID reader according to claim 32, further comprising:
a plurality of antennas;
a plurality of interrogation protocols; and
wherein the processor adapts its usage of the interrogation modes by varying an order in which at least some of said plurality of antennas and interrogation protocols are combined.

41. An RFID reader according to claim 32, wherein the processor adapts its usage of the interrogation modes when the RFID reader receives no tag transmission energy.

42. A method for conserving power in an RFID reader capable of operating according to a plurality of interrogation modes when interrogating a set of one or more RFID tags, the method comprising:
collecting data related to interrogation efficacy of one or more of the interrogation modes; and
adapting usage of the interrogation modes so as to conserve power, based on the stored data.

43. A method according to claim 42, further comprising:
updating the stored data based on new results from continued operation of the RFID reader.

44. A method according to claim 42, wherein the adapting step comprises adapting at least one of a duty cycle at which the RFID reader transmits an interrogation signal, a frequency band at which the RFID reader transmits an interrogation signal, and a frequency hopping profile according to which the RFID reader transmits an interrogation signal.

45. A method according to claim 42, wherein the adapting step comprises excluding at least one interrogation protocol from use.

46. A method according to claim 42, wherein the RFID reader comprises a plurality of antennas, and wherein the adapting step comprises excluding at least one of said plurality of antennas from use.

47. A method according to claim 42, wherein the RFID reader comprises a plurality of antennas and interrogation protocols, and wherein the adapting step comprises excluding at least one combination of one of said plurality of antennas and interrogation protocols from use.

48. A method according to claim 42, wherein the adapting step comprises varying an order in which a plurality of interrogation protocols are used.

49. A method according to claim 42, wherein the RFID reader comprises a plurality of antennas, and wherein the adapting step comprises varying an order in which at least some of said plurality of antennas are used.

50. A method according to claim 42, wherein the RFID reader comprises a plurality of antennas and interrogation protocols, and wherein the adapting step comprises varying an order in which at least some of said plurality of antennas and interrogation protocols are combined.

51. A portable RFID reader capable of operating in a plurality of interrogation modes, the RFID reader comprising:
a means for collecting data related to interrogation efficacy of one or more of the interrogation modes; and
a means for adapting usage of the interrogation modes so as to conserve power, based on the stored data.
